(19) United States
(12) Patent Application Publication
(10) Pub. No.: US 2023/0102677 A1
(43) Pub. Date: Mar. 30, 2023

(54) ELECTRIC POWER UNIT

(71) Applicant: NIDEC CORPORATION, Kyoto (JP)

(72) Inventors: Hiroki AKAISHI, Kyoto (JP); Kazuyuki YAMAMOTO, Kyoto (JP); Daisuke OGASAWARA, Kyoto (JP); Shuhei NAKAMATSU, Kyoto (JP)

(21) Appl. No.: 17/955,547

(22) Filed: Sep. 29, 2022

(30) Foreign Application Priority Data
Sep. 30, 2021 (JP) 2021-161273

(51) Int. Cl. H02K 11/33; H02K 5/04

(52) U.S. Cl. CPC H02K 11/33; H02K 5/04

(57) ABSTRACT

In an electric power unit including: an electric motor accommodated in a motor accommodating portion formed in a housing; an inverter accommodated in an inverter accommodating portion formed in an upper portion of the housing; and a harness storing portion that is provided in the inverter accommodating portion and protrudes from an end surface of the housing in a motor-axis direction, at least one fastening portion that supports the harness storing portion from below is formed in the harness storing portion, the fastening portion is provided with a seat surface and at least one rib adjacent to the seat surface and connected to a lower surface of the inverter accommodating portion, and the harness storing portion is fastened to the housing by a bolt (fastener) inserted into the seat surface.

### CROSS-REFERENCE TO RELATED APPLICATIONS

The present invention claims priority under 35 U.S.C. § 119 to Japanese Patent Application No. 2021-161273 filed on Sep. 30, 2021, the entire content of which is incorporated herein by reference.

### FIELD OF THE INVENTION

The present invention relates to an electric power unit using an electric motor as a driving source.

### BACKGROUND

In recent years, an electric vehicle (EV) that uses an electric motor as a driving source has been actively developed instead of a vehicle that uses an engine discharging exhaust gas as a driving source. Further, the electric vehicle is equipped with a power unit configured by integrally incorporating, in a housing, the electric motor (an alternating current (AC) motor) that is the driving source, an inverter that converts a direct current (DC) current from a DC power supply, such as a battery, into an AC current and supplies the AC current to the electric motor; a speed reduction mechanism that decelerates (increases a torque for) rotation of the electric motor, a differential mechanism (differentiating mechanism) that differentiates the rotation output from the speed reduction mechanism to left and right output shafts, and the like.

Meanwhile, uncomfortable vibration and noise are imparted to an occupant in a case where the vibration of the power unit incorporating the electric motor, which is a vibrating source, is large, and thus, it is desired to suppress the vibration and noise of the power unit to be low.

As a method for suppressing the vibration of the electric motor to be low, there are known a method of reducing vibration by changing a distance of an air gap at each tooth tip of a stator core by a magnetic structure of the electric motor to offset a specific electromagnetic vibrating force component generated in the stator core, a method of reducing vibration of a specific order by offsetting an electromagnetic force generated in the stator core by current control, and the like.

There is also known a method of enhancing rigidity of a motor housing that accommodates the electric motor to suppress vibration and noise of the motor housing to be low. For example, conventionally, there is proposed a configuration in which the number of reinforcing ribs of a flange of a motor housing is set to a number that is not a divisor of the number of slots of a stator, is not a multiple of the number of slots, is not a divisor of the number of poles of a rotor, and is not a multiple of the number of poles.

Further, conventionally, there is proposed a configuration in which a rubber mount supporting a power plant including an engine against a vehicle body frame is joined to the power plant via an engine-side mount bracket, and the movement of the rubber mount is restrained by a restraint device including an electromagnet joined to the engine-side mount bracket and a vehicle-frame-side mount bracket via a prop to increase the spring rigidity of the rubber mount, whereby vibration of the power plant generated when the engine is started and stopped is suppressed to be low.

Meanwhile, in an electric power unit including an inverter, the inverter is accommodated in an inverter accommodating portion formed integrally with a housing, and an opening of the inverter accommodating portion is closed by an inverter cover that is detachable. Further, a harness storing portion configured to store a harness extending from a DC power supply, such as a battery, is integrally formed in the inverter cover, and the harness storing portion may protrude (overhang) from an end surface of the housing.

In the electric power unit including the inverter cover in which the harness storing portion protrudes (overhangs) from the end surface of the housing as described above, the rigidity of the inverter cover is low, and thus, the inverter cover resonates due to vibration generated by driving of an electric motor and becomes a noise source, and there is a problem that a noise level radiated from the inverter cover increases.

### SUMMARY

An exemplary electric power unit of the invention is an electric power unit including: an electric motor accommodated in a motor accommodating portion formed in a housing; an inverter accommodated in an inverter accommodating portion formed in an upper portion of the housing; and a harness storing portion that is provided in the inverter accommodating portion and protrudes from an end surface of the housing in a motor-axis direction. In the electric power unit, at least one fastening portion that supports the harness storing portion from below is formed in the harness storing portion, the fastening portion is provided with a seat surface and at least one rib adjacent to the seat surface and connected to a lower surface of the inverter accommodating portion, and the harness storing portion is fastened to the housing by a fastener inserted into the seat surface.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a longitudinal sectional view schematically illustrating the entire configuration of an electric power unit according to the present invention as viewed from the rear side of a vehicle;

FIG. 2 is a perspective view of the electric power unit according to the present invention as viewed from the obliquely left rear side;

FIG. 3 is an enlarged detailed view of a main part of FIG. 2; and

FIG. 4 is a view illustrating a relationship between a motor rotational speed and a noise level of the electric power unit according to the present invention in comparison with that of a conventional electric power unit.

### DETAILED DESCRIPTION

Hereinafter, an embodiment of the present invention will be described with reference to the drawings.

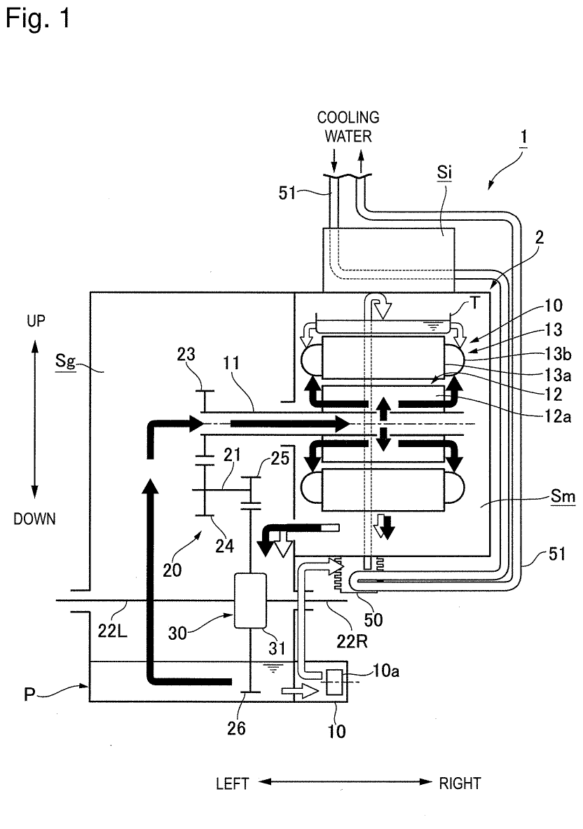

FIG. 1 is a longitudinal sectional view schematically illustrating the entire configuration of an electric power unit according to the present invention as viewed from the rear side of a vehicle, and an electric power unit 1 illustrated in the drawing is mounted on an electric vehicle (EV). In FIG. 1, arrow directions are defined as an “up-down” direction and a “left-right” direction (vehicle width direction), respectively, as illustrated in the drawing.

In the electric power unit 1 according to the present embodiment, an electric motor 10, which is a driving source, is accommodated in a motor accommodating portion (motor chamber) Sm formed in the right half inside a housing 2 produced by aluminum die-casting, and a speed reduction mechanism 20 and a differential mechanism (differentiating mechanism) 30 are accommodated in a gear accommodating portion (gear chamber) Sg formed in the left half inside the housing 2. Further, an inverter (not illustrated) is accommodated in an inverter accommodating portion Si formed in an upper portion of the housing 2. The inverter is configured to convert a DC current from a battery, which is a DC power supply and is not illustrated, into an AC current and supply the AC current to the electric motor 10, and includes a control element such as an insulated gate bipolar transistor (IGBT).

Here, the electric motor 10 is a three-phase AC motor, and includes a rotor 12, which rotates together with a hollow shaft (motor shaft) 11 passing through the center of the rotor 12, and a cylindrical stator 13 fixed around the rotor 12. Here, the shaft 11 is horizontally arranged along a left-and-right direction (vehicle width direction) in FIG. 1, and the rotor 12 fixed to the outer periphery of the shaft 11 includes a rotor core 12a and a permanent magnet (not illustrated) embedded in the rotor core 12a. Further, the stator 13 includes a stator core 13a and a coil 13b, and the coil 13b is electrically connected to the inverter.

Meanwhile, inside the gear accommodating portion Sg, a counter shaft 21 and left and right output shafts 22L and 22R are arranged in parallel to the shaft 11. The speed reduction mechanism 20 includes: a first gear 23 affixed to an outer periphery of a left end portion facing the inside of the gear accommodating portion Sg of the shaft 11; a second gear 24 and a third gear 25 having different diameters and affixed to the counter shaft 21; and a ring gear 26 having a large diameter connected to a differential case 31 of the differential mechanism 30. Here, the first gear 23 and the second gear 24 mesh with each other, and the third gear 25 and the ring gear 26 mesh with each other.

The differential mechanism 30 functions to absorb a rotational difference between left and right drive wheels at the time of cornering of a vehicle or the like and transmit power to each of the left and right output shafts 22L and 22R and has a known configuration, and thus, a detailed description thereof is omitted here, but a pair of pinion gears and side gears respectively meshing with the pinion gears are accommodated in the differential case 31. Note that an oil pan P is provided at the bottom of the gear accommodating portion Sg of the housing 2, and a predetermined amount of oil is stored in the oil pan P. Further, a portion (outer peripheral portion) of the ring gear 26 is immersed in the oil stored in the oil pan P.

In the electric power unit 1 according to the present embodiment, an oil pump 40 and an oil cooler 50, which are auxiliary machines, are attached to the housing 2. Here, the oil pump 40 is rotationally driven by a pump motor 41 which is a driving source. Further, a cooling water pipe 51 extending from a radiator (not illustrated) and passing through the inverter accommodating portion Si is connected to the oil cooler 50, and the oil is cooled in the oil cooler 50 by heat exchange with a cooling water. Then, the cooling water provided to cool the oil in the oil cooler 50 is returned from the cooling water pipe 51 to the radiator (not illustrated). In this manner, the cooling water continuously circulates in a closed circuit to cool the inverter (not illustrated) and the oil accommodated in the inverter accommodating portion Si.

In the electric power unit 1 configured as described above, when a DC current is output from the battery (not illustrated), the DC current is converted into an AC current by the inverter (not illustrated). When the AC current is supplied to the electric motor 10, the electric motor 10 is rotationally driven by electromagnetic induction action. That is, the rotor 12 and the shaft 11 of the electric motor 10 are rotationally driven at a predetermined speed, and the rotation is decelerated at a predetermined reduction ratio by the speed reduction mechanism 20 and transmitted to the differential mechanism 30. Then, the rotation transmitted to the differential mechanism 30 is distributed to the left and right by the differential mechanism 30 and transmitted to each of the left and right output shafts 22L and 22R, and both the output shafts 22L and 22R rotate at a predetermined speed.

Although not illustrated, the left and right output shafts 22L and 22R are connected to left and right axles, respectively, and the left and right drive wheels are attached to end portions of the left and right axles, respectively. Therefore, when the left and right output shafts 22L and 22R rotate as described above, the drive wheels (not illustrated) attached to both the axles are rotationally driven, whereby the vehicle travels at a predetermined speed.

When the electric power unit 1 is driven as described above, the oil pump 40 is driven by the pump motor 41, and the cooling water circulates through the closed circuit by a cooling water pump (not illustrated).

Meanwhile, since a portion (the outer peripheral portion) of the ring gear 26 is immersed in the oil stored in the oil pan P provided at the bottom of the gear accommodating portion Sg of the housing 2 as described above, the oil in the oil pan P is scraped up by the rotation of the ring gear 26. A part of the scraped oil is supplied to each portion of the electric motor 10 through the shaft 11 as indicated by an arrow in FIG. 1 to be used for lubrication and cooling of each portion. Then, the oil provided for lubrication and cooling of each portion of the electric motor 10 drops into the oil pan P and is collected as indicated by an arrow in FIG. 1.

Further, another part of the oil scraped up by the ring gear 26 is supplied for lubrication and cooling of the speed reduction mechanism 20 and the differential mechanism 30, and then, drops into the oil pan P to be collected. Then, a part of the oil in the oil pan P is sent to the oil cooler 50 by the oil pump 40, and is cooled by heat exchange with the cooling water flowing through the cooling water pipe 51 in the oil cooler 50 as indicated by an arrow in FIG. 1. Then, the cooled oil is sent to a tray T arranged in an upper portion of the electric motor 10, and the oil overflowing from the tray T falls to the electric motor 10 to be used for lubrication and cooling of each part of the electric motor 10 as indicated by an arrow in FIG. 1. The oil supplied for lubrication and cooling of each portion of the electric motor 10 in this manner is returned to the oil pan P at the inner bottom of the gear accommodating portion Sg to be collected.

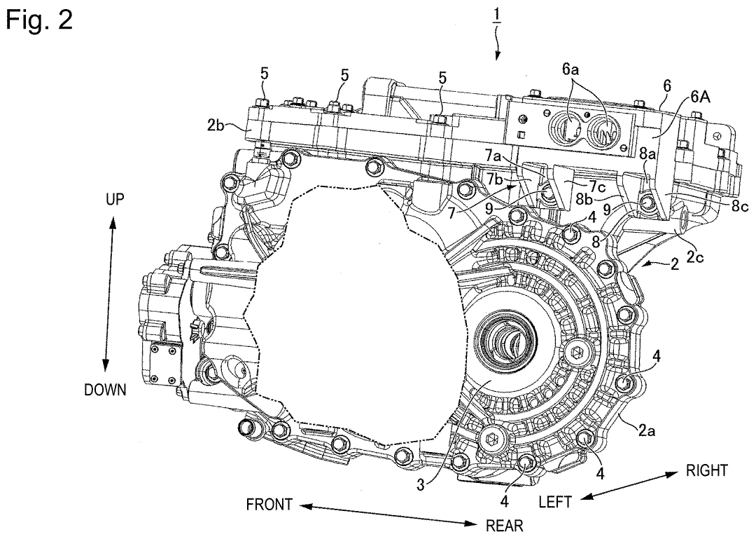

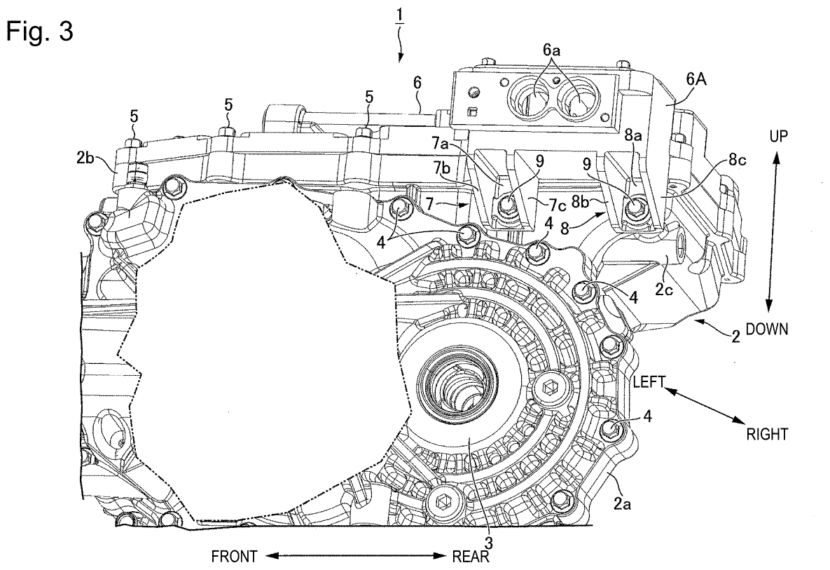

Next, a specific configuration of the electric power unit 1 according to the present invention will be described hereinafter with reference to FIGS. 2 and 3.

FIG. 2 is a perspective view of the electric power unit according to the present invention as viewed from the obliquely left rear side; and FIG. 3 is an enlarged detailed view of a main part of FIG. 2. In FIGS. 2 and 3, arrow directions are “front-and-rear”, “left-and-right”, and “up-and-down” directions, respectively, as illustrated in the drawings.

As illustrated in FIG. 1, the electric motor 10 is accommodated in the right half inside the housing 2 of the electric power unit 1, the speed reduction mechanism 20 and the differential mechanism 30 are accommodated in the left half, and openings (not illustrated) are formed on the left and right of the housing 2. As illustrated in FIGS. 2 and 3, a flange portion 2a is formed on a peripheral edge of the opening on the left side of the housing 2, and a gear cover 3 is detachably attached to the flange portion 2a by a plurality of bolts 4. Therefore, the opening on the left side of the housing 2 is closed by the gear cover 3. Although not illustrated, a flange portion is formed at a peripheral edge of the opening on the right side of the housing 2, and a motor cover is detachably attached to the flange portion by a plurality of bolts. Therefore, the opening on the right side of the housing 2 is closed by the motor cover.

Further, a flange portion 2b is integrally formed on a rear upper surface of the housing 2 as illustrated in FIGS. 2 and 3, and a space surrounded by the flange portion 2b constitutes the inverter accommodating portion Si illustrated in FIG. 1. Then, the inverter (not illustrated) is accommodated in the inverter accommodating portion Si.

Further, an upper surface of the inverter accommodating portion Si (see FIG. 1) is opened, and such an upper surface opening is closed by an inverter cover 6 detachably attached to the flange portion 2b by a plurality of bolts 5. Note that the inverter cover 6 is also integrally molded by aluminum die-casting.

Meanwhile, a harness storing portion 6A having a rectangular box shape is integrally formed at a left rear end (a front side of a right end portion in FIGS. 2 and 3) of the inverter cover 6. The harness storing portion 6A protrudes (overhangs) from a left end surface (end surface on the front side in FIGS. 2 and 3) of the housing 2 toward the left side (front side in FIGS. 2 and 3) in a motor-axis direction (left-and-right direction). Further, circular holes 6a into which two harnesses (not illustrated) extending from a battery (not illustrated), which is a DC power supply, are inserted are opened at the front and rear (left and right in FIGS. 2 and 3) of a left end surface (end surface on the front side in FIGS. 2 and 3) of the harness storing portion 6A.

Further, two front and rear (left and right in FIGS. 2 and 3) fastening portions 7 and 8 configured to support the harness storing portion 6A from below are formed in the harness storing portion 6A. The fastening portions 7 and 8 are provided with seat surface 7a and 8a, which are vertical planes, and a pair of front and rear (left and right in FIGS. 2 and 3) ribs 7b and 7c, and 8b and 8c adjacent to the seat surfaces 7a and 8a, respectively. In each of the fastening portions 7 and 8, the seat surfaces 7a and 8a are sandwiched by the pair of ribs 7b and 7c and the pair of ribs 8b and 8c, respectively, from the front and rear (left and right in FIGS. 2 and 3).

Here, each of the pair of ribs 7b and 7c, and the pair of ribs 8b and 8c has a width being widened in a protruding direction (left side) of the harness storing portion 6A as proceeding upward. Therefore, the rigidity of each of the fastening portions 7 and 8 is enhanced by the pair of ribs 7b and 7c, and the pair of ribs 8b and 8c. Note that a bolt insertion hole (not illustrated) having a circular hole shape is formed in each of the seat surfaces 7a and 8a.

When viewed in the motor-axis direction (when viewed from the front side to the back side in FIGS. 2 and 3), an outer end portion (a right end portion in FIGS. 3 and 3) of a rear end of the harness storing portion 6A is integrated with the rib 8b closer to an end portion of the fastening portion 8 on the outermost side (the right end side in FIGS. 2 and 3). Then, the pair of fastening portions 7 and 8 formed in the harness storing portion 6A is arranged apart from each other by a predetermined distance in the front-and-rear direction (the left-and-right direction in FIGS. 2 and 3).

Further, the harness storing portion 6A protruding (overhanging) from the end surface (left end surface) of the housing 2 of the inverter cover 6 is fastened to the housing 2 by screwing bolts 9, which are fasteners inserted into the bolt insertion holes (not illustrated) formed in the respective seat surfaces 7a and 8a of the pair of front and rear (in FIGS. 2 and 3, the pair of left and right) fastening portions 7 and 8, into the end surfaces (left end surfaces) of the housing 2 and a cylindrical boss 2c that is integrated with and protrudes from the housing 2, and is supported from below by the housing 2. Note that the boss 2c integrated with the housing 2 to protrude to the rear side (right side in FIGS. 2 and 3) is used at the time of assembling the electric power unit 1.

As described above, in the electric power unit 1 according to the present embodiment, the harness storing portion 6A protruding (overhanging) from the end surface of the housing 2 of the inverter cover 6 is fastened to the housing 2 by the bolts 9 inserted into the pair of front and rear (in FIGS. 2 and 3, the pair of left and right) fastening portions 7 and 8, whereby the harness storing portion 6A is supported from the lower side by the housing 2. Thus, the support rigidity of the harness storing portion 6A is enhanced. In this case, the rigidity of the fastening portions 7 and 8 formed in the harness storing portion 6A is effectively enhanced by the pair of ribs 7b and 7c and the pair of ribs 8b and 8c. In addition, one fastening portion 7 is fastened to the boss 2c having high rigidity and integrated with and protruding from the housing 2.

As a result, the rigidity of the harness storing portion 6A against bending and twisting in the up-and-down direction of the vehicle is enhanced, the rigidity of the entire inverter cover 6 is also enhanced, and a noise level caused by resonance of the inverter cover 6 due to vibration at the time of driving the electric motor 10, which is a vibrating source, is suppressed to be low.

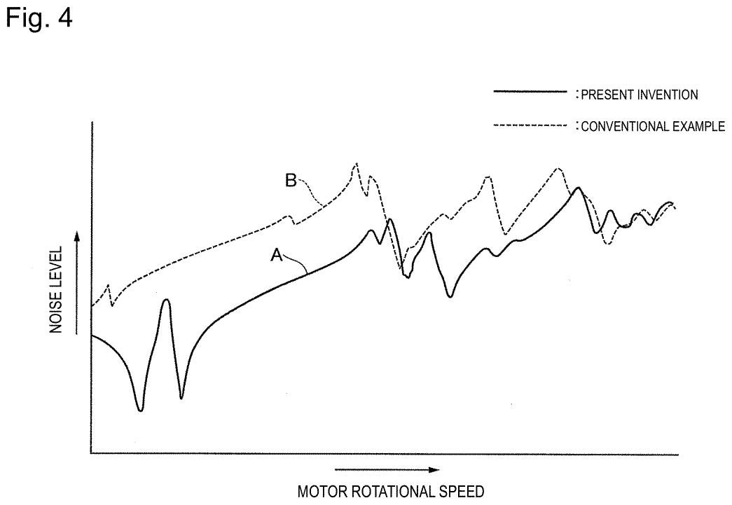

Here, FIG. 4 illustrates a relationship between a motor rotational speed and the noise level of the electric power unit 1 according to the present invention in comparison with that of a conventional electric power unit. The noise level of the electric power unit 1 according to the present invention is suppressed to be lower than the conventional noise level, indicated by a broken line B in FIG. 4, in the entire range of the motor rotational speed as indicated by a solid line A in FIG. 4.

Note that, assuming that a circular constant is n, a mass is m, and a spring constant (rigidity) is k, a natural frequency f that generates resonance is obtained by the following formula:

f=½Π·(k/m)^{1/2}

and thus, as illustrated in FIG. 4, primary, secondary, and tertiary resonance points and so on (points at which peaks of the noise level appear) shift to a high rotational speed side when the rigidity (spring constant k) is increased.

Although the two front and rear fastening portions 7 and 8 are formed in the harness storing portion 6A of the inverter cover 6 in the above embodiment, the number of the fastening portions is arbitrary, and three or more fastening portions may be formed.

Additionally, the present invention is not limited to the embodiment described above, and various modifications can be made within the scope of the technical idea described in the scope of claims, the specification, and the drawings.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. An electric power unit comprising:
an electric motor accommodated in a motor accommodating portion formed in a housing;
an inverter accommodated in an inverter accommodating portion formed in an upper portion of the housing; and
a harness storing portion that is provided in the inverter accommodating portion and protrudes from an end surface of the housing in a motor-axis direction,
wherein at least one fastening portion that supports the harness storing portion from below is formed in the harness storing portion,
the fastening portion is provided with a seat surface and at least one rib adjacent to the seat surface and connected to a lower surface of the inverter accommodating portion, and
the harness storing portion is fastened to the housing by a fastener inserted into the seat surface.

2. The electric power unit according to claim 1, wherein
the harness storing portion is provided in an inverter cover that covers an upper surface opening of the inverter accommodating portion.

3. The electric power unit according to claim 1, wherein
the rib has a width that is widened in a protruding direction of the harness storing portion as proceeding upward.

4. The electric power unit according to claim 1, wherein
the seat surface of the fastening portion is sandwiched by a pair of the ribs from both sides in a direction orthogonal to a motor axis.

5. The electric power unit according to claim 1, wherein
a pair of the fastening portions is formed at two locations in a direction orthogonal to a motor axis.

6. The electric power unit according to claim 1, wherein
an outer end portion of the harness storing portion is integrated with the rib closer to an end portion of the fastening portion on an outermost side as viewed in the motor-axis direction.

7. The electric power unit according to claim 1, wherein
the fastener is a bolt.

8. The electric power unit according to claim 1, wherein
one of the fastening portions is fastened to a boss that is integrally formed with the housing and extends in a direction orthogonal to a fastening direction.
